(19) United States
(12) Patent Application Publication
(10) Pub. No.: US 2017/0209719 A1
(43) Pub. Date: Jul. 27, 2017

(54) FACE MASK

(71) Applicant: TIEH-CHUN TANG, WEST COVINA, CA (US)

(72) Inventor: TIEH-CHUN TANG, WEST COVINA, CA (US)

(21) Appl. No.: 14/998,629

(22) Filed: Jan. 21, 2016

(51) Int. Cl. A62B 23/02; A62B 9/00; A62B 18/10; A62B 18/02; A62B 18/08

(52) U.S. Cl. CPC A62B 23/025; A62B 18/025; A62B 18/084; A62B 18/10; A62B 9/003

(57) ABSTRACT

A sterilization germ killing comfort mask, including mask layers held in the mask with a fixed belt. There is a sterilization filter layer, an electrostatic layer, a far-infrared superfine calcium layer, and a facial protection layer from outside to inside of mask body. In use, the outside air passes through a first sterilization filter layer, the preliminary filtration sterilization filter layer removes larger grains of dust and sterilization, electrostatic layer can filter through the sterilization of dust. Superfine calcium far-infrared layer removes acidic dust, bacteria and oily molecular adsorption, and neutralize the acid molecules, sterilization and decomposition of oily molecules absorbed. Facial protection layer strengthen filtering and protection of facial skin. This mask for the various molecules in air dust filtration and sterilization, sterilization dust removal ability, remove the inclusion of peculiar smell in the air at the same time, guarantee the quality of air that users breathe, and the user to wear comfortable, strong practicability.

### FIELD OF THE INVENTION

The invention relates to a multi-layer face mask for filtering contaminants from the air, and to the separate layers therein.

### BACKGROUND TECHNOLOGY

In today's serious atmospheric pollution, highly attention to the quality of the air, affecting the quality of air is mainly small molecules dust in the air. People are afraid of the dust for small molecules, the reason is that it can penetrate and spread throughout the body. Dust can quickly be absorbed directly into the blood and circulate throughout the body. It also can damage the hemoglobin oxygen supply. For patients with anemia or limited blood circulation it could have serious consequences. For example, it can aggravate respiratory system diseases, and even cause congestive heart failure and coronary heart disease.

Everywhere, people are now living in big cities, and traveling with masks, as a part of normal life security. But the ability of existing masks to remove small dust particles is very poor. For the large amount of acid fog haze MP2.5 air dust small particles and acid molecules, the traditional masks like 3M's N95 mask may have filtering function, but N95's ability to block the oily dust is very poor. N95 is very uncomfortable and cannot be worn very long.

### SUMMARY OF THE INVENTION

The multi-layer face mask of the invention fully filters and removes all contaminants from the air. The mask has complete strilization ability; is very sturdy, and it wears comfortably on the face.

In order to solve the polution problems, using a technical scheme, a sterilization germ killing comfort mask, including mask layers held in the mask body by a fixed band. There are set of sterilization filter layer, electrostatic layer, far-infrared susperfine calcium layer and facial protection layer from outside to inside of face mask.

The mask includes a one-way exhaust valve and a thermal layer outside the sterilization filtration layer. The thermal layer is made of self-heating material, and a heating piece placed to help heat the material.

There are several layers in the mask body. The sterilization filter layer is made from non-woven fabric containing calcium ions. The electrostatic layer is made of electrostatic material. The superfine calcium far-infrared layer is made of superfine calcium ions held by non-woven fabrics. Facial protection layer is prevents dryness, and is preferably non-woven material.

The mask is used by covering the user's nose and mouth with the fixed belt on the mask body. The outside air passes through the sterilization filter layer first, to filter the large dust particles, and sterilize the air.

The electrostatic layer filters with the sterilization of dust, which include MP2.5 acid contamination dust adsorption. Far-infrared superfine calcium receives air passed through the outer two layers, to remove remaining acidic dust, bacteria and oily molecular adsorption, and neutralize the acid molecules, sterilization and decomposition of oily molecules absorbed.

Facial protection strengthen filtering and protection of facial skin, make the user comfortable wearing. It has a multi-layer laminated structure. It filters the various molecules in air dust and does the sterilization. It removes the peculiar smell in the air, guarantees the quality of air the user breathes, and is worn comfortably.

Description of drawing:

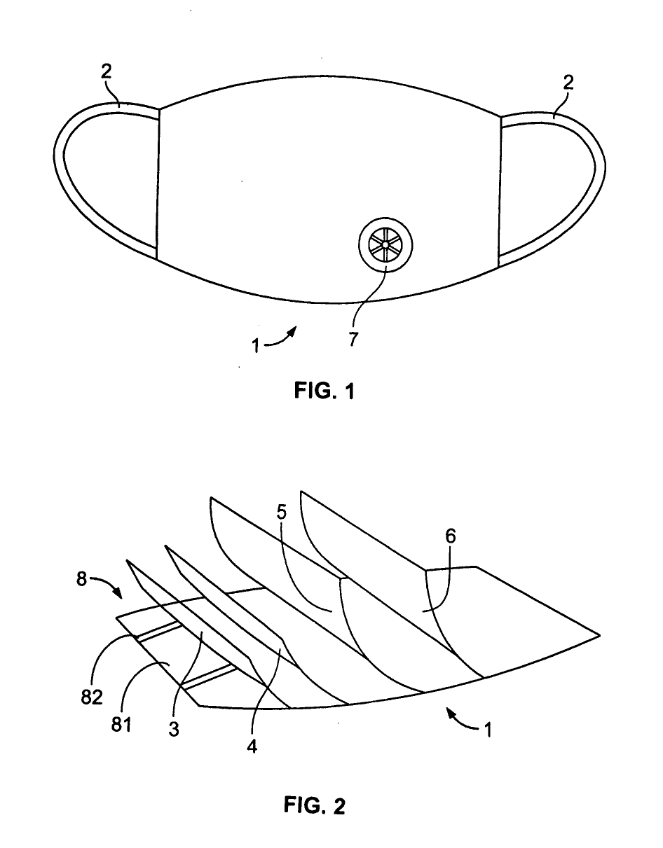

FIG. 1 shows the planar structure diagram.

FIG. 2 shows the separate layers of the structure.

### SPECIFIC EMBODIMENTS

As shown in drawing 1 and drawing 2, The sterilization germ killing comfort mask, including mask layers set in the mask body 1 and fixed with belt 2. Described in the mask set 1 from inner to outer in sterilization filtration layer 3. electrostatic layer 4. Superfine calcium far-infrared 5 and facial protection 6.

In practice, belt 2 fixes the mask on the user's face so it covers the user's nose and mouth. Outside air passes through a first sterilization filtration layer 3, the preliminary filtration layer 3, filtered the large grain of dust and do the sterilization. Electrostatic layer 4 can Filter through whatever left from layer 3 which include MP2.5 acid contamination dust adsorption on. Far-infrared superfine calcium layer 5 sterilizes by removing dust and bacteria; and absorbing oily substances and neutralizing acid molecules, and decomposition of oily molecules absorbed. Facial protection layer 6, strengthened filtering and protection of facial skin make the user comfortable wearing.

This mask adopts multi-layer laminated structure, on the various molecules in air dust filtration and sterilization, strong sterilization dust removal ability, remove the inclusion of peculiar smell in the air at the same time, guarantee the quality of user's breathe air and the user to wear comfortably, very practically. The one-way exhaust valve 7 install in the mask body 1 which can only be get rid of the exhaled air. Due to the air is through the mask body 1 layer upon layer filter, masks, both inside and outside air exchange relatively smooth enough, one-way exhaust valve 7 exclude user's exhaled air one-way. Increased the mask inside and outside air pressure, the masks of inside and outside of the air exchange, makes users comfortable wearing and can be long wearing.

The heating layer 8 outside the sterilization filtration layer contains spontaneous heat fiber 81 and used to the spontaneous heat fiber 81 heating electric leaf 82. Both spontaneous electric leaf fiber heat 81 and 82 are existing fiber material. In the process of practical application, the electric leaf set to absorb the solar energy heating 82, heating 82 transfers the heat to heating fiber 81.

In cold winter, some people wear surgical masks to keep warm, but they took the mask only as the function of keep warm, it cannot filter the dust and cannot achieve sterilization. Wearing only a surgical mask allows dangerous contaminants to pass through, and cause great harm to the lungs and human body.

With hot layer 8, it makes users get warm at the same time and breathe healthy air. Guarantee the quality of the breathing air. This mask can be used in many area.

Some of the mask layers include folds or wrinkles; namely in the sterilization filtration layer 3, electrostatic layer 4, superfine calcium far-infrared 5 and facial protection layer 6 has some wrinkles. This increases the efficiency of filtration and sterilization, to make the users breathe easier and more comfortably.

The described sterilization filtration layer 3 is made from non-woven fabric containing silver ions. This non-woven fabric is made of 2 grams non-woven fabrics which possess the sterilization filtration layer 3 with silver ions which can filter the large dust float in the air for preliminary filtration and sterilization to ensure that the user breathes good quality air.

The electrostatic layer 4 is made of existing electrostatic materials. Through sterilizing filter layer 3 intercepted the dust, the dust in the vast majority are electrically charged particles, after sterilization filtration layer 3, by electrostatic adsorption layer 4.

The far-infrared superfine calcium layer 5 includes non-woven fabric containing superfine calcium obtained from processing marine pearl, giant clam, shell and so on for the extraction of raw materials. The superfine calcium is a known, commercially available material. Processes for making and coating non-woven fabrics are well-known. See for example U.S. Pat. No. 4,100,324, U.S. Pat. No. 3,542,615, and U.S. 5,055,340. Known sources of far infrared ions include tourmaline, zeolite, perlite, and serpentine.

Micro far-infrared calcium level 5 can be through the two outer layer of the acidity of dust, bacteria and oily molecular adsorption and neutralize the acid molecules, sterilization and decomposition of oily molecules absorb, can eliminate peculiar smell in the air, guarantee the quality of users breathe air.

The facial protection layer 6 is made of 20 grams moisturizing non-woven materials which preventing users face dry, and makes users comfortable wearing.

Other variations of the illustrated mask are easily made, and they fall within the scope of the invention.

Also, layer 5 is separately inventive, because it is useful in other systems. For example, it is useful as an air filter in furnace systems and air-conditioning systems. It is useful as a filter for purification of water; as a deodorant pad in shoes; as a sterile bandage for wounds; and useful in women's tampons.

1. A sterilized germ killing comfort mask, including the mask body (1) and a fixed belt (2) set in the mask body (1), including from outside to inside respectively, a sterilization filtration layer (3) electrostatic layer (4) superfine calcium far-infrared layer (5) and facial protection layer (6).

2. According to claim 1, a kind of sterilized germ killing comfort masks, further including a one-way valve (7) set in the mask body (1).

3. According to claim 1, a kind of sterilized germ killing comfort masks, further including heat layer (8).

4. According to claim 3, a kind of sterilized germ killing comfort masks, further including spontaneous heat fiber (81) in combination with the spontaneous heating electric leaf (82).

5. According to claim 1, a kind of sterilization germ killing comfort mask, whose character includes some wrinkles.

6. According to claim 1, a kind of sterilized germ killing comfort mask, wherein said sterilization filtration layer (3) comprises a non-woven fabric containing silver ions.

7. According to claim 1, a kind of sterilized germ killing comfort masks, wherein said electrostatic layer (4) is made of electrostatic material.

8. According to claim 1, a kind of sterilized germ killing comfort mask wherein said super fine calcium layer (5) comprises a non-woven fabric containg superfine calcium ions.

9. According to claim 1, a kind of sterilized germ killing comfort mask, wherein said facial protection layer (6) comprises a non-woven material to prevent facial skin dryness.

10. A filtration layer comprising a non-woven fabric containing superfine calcium and far infrared ions.
